(19) United States
(12) Patent Application Publication
(10) Pub. No.: US 2025/0232352 A1
(43) Pub. Date: Jul. 17, 2025

(54) CONTENT PERSONALISATION SYSTEM AND METHOD

(71) Applicant: COVATIC LTD, Birmingham (GB)

(72) Inventors: Nicholas Pinks, Birmingham (GB); Daniel Pike, Birmingham (GB); James Holyhead, Birmingham (GB); Stephen Browett, Birmingham (GB); Nathanael Farley, Birmingham (GB); Julia Kuskowska, Birmingham (GB)

(21) Appl. No.: 18/854,488

(22) PCT Filed: Apr. 25, 2023
(86) PCT No.: PCT/GB2023/051090

§ 371 Date: Oct. 4, 2024

(30) Foreign Application Priority Data
Apr. 25, 2022 (GB) 2206023.0

(51) Int. Cl. G06Q 30/0601

(52) U.S. Cl. CPC G06Q 30/0631

(57) ABSTRACT

A content personalisation system comprising: a presence determination component in communication with a device database, the presence determination component comprising a network device defining a network zone; wherein the presence determination component is configured to: determine the presence of a consumer within the network zone based on data in the device database; a device database in communication with the presence determination component; a content generation component in communication with the presence determination component, a content database, and a content device; wherein the content generation component is configured to: provide a current content item to the content device associated with the consumer; generate a personalised content item based on data in the content database associated with the consumer; and provide the personalised content to the content device; and wherein: the device database comprises data indicative of one or more devices that have previously connected to the network device; and the content database comprises data indicative of one or more content items that have been previously presented.

### FIELD OF THE INVENTION

The present invention relates to a system and method for providing personalised content to a content device.

### BACKGROUND TO THE INVENTION

Laws, regulations and policies regarding user privacy in an online environment restrict the amount and type of data that can be provided to content providers. Providing personalised content to a consumer via a display device such as a television using a set-top box is increased in difficulty due to the lack of data provided to the content providers.

The present disclosure has been division to mitigate the above-mentioned problem.

### SUMMARY OF THE INVENTION

In accordance with a first aspect of the present invention, there is provided a content personalisation system comprising: a processor; a presence determination component comprising a network device defining a network zone; a device database in communication with the presence determination component, the device database comprising data indicative of one or more devices that have previously connected to the network device; a content generation component in communication with the presence determination component; and a content database in communication with the content generation component, the content database comprising data indicative of one or more content items that have been previously presented; wherein: the presence determination component is configured to: determine the presence of a consumer within the network zone based on data in the device database; the content generation component is configured to: provide a current content item to a content device associated with the consumer; generate a personalised content item based on data in the content database associated with the consumer; and provide the personalised content to the content device.

The consumer may be understood as a person who is consuming the current content item on the content device. The content item may be a video content item such that the content device may be a display device such as a television. Additionally or alternatively, the content item may be an audio content item such that the content device consists of or comprises an audio content device such a loudspeaker.

The presence determination component may be understood as a device suitable for determining the presence of a consumer within an area, the area being a network zone of a network device. The presence determination component may further comprise electronic components, such as a processor configured to control actions of the presence determination component.

The network device may refer to a device suitable for receiving and providing data to a user device. For example, the network device may be a router. However, the skilled reader will understand that further network devices may be envisaged, such as a smart-speaker or a smart-television. Advantageously, the network device may provide a means for the system to connect and communicate with one or more consumer devices associated with the consumer. The network zone may refer to a space or range at which devices are able to connect to the network device.

The content generation component may be understood as a device suitable for controlling content provided to the content device, and generating personalised content items for the content device. The content generation component may comprise electronic components, such as a processor configured to control actions of the content generation component.

The device database may refer to a database comprising data indicative of consumer devices that have previously connected with the network device. The device database may be part of the network device, or may be remote from the network device. The network device may be configured to record, on the device database, an identifier of a device that has connected with the network device. Advantageously, the network device may be able to maintain and update data indicative of a history of devices that have connected to the network device.

The content database may refer to a database comprising data indicative of content that has been previously presented or consumed to the consumer or viewer. The content database may be part of the content generation component, or may alternatively be remote from the network device. The network device may be configured to record, on the device database, an identifier of a device that has connected with the network device. Advantageously, the network device may be able to maintain and update data indicative of a history of devices that have connected to the network device.

The present system may determine that a consumer or viewer is present within the network zone based on historic device connection data. In this way, the presence of the consumer or viewer may be determined based on device connection data alone. Advantageously, the system may provide a means for determining the presence of a consumer without the use of any personal data.

The system may also provide personalised content to the consumer or viewer via a display device, wherein the personalised content is generated based on historic content data related to content items that the consumer or viewer has previously been presented to and consumed by the consumer or viewer. Advantageously, the system may provide a means for providing personalised content whilst collecting and processing a minimised amount of data.

Preferably, the presence determination component determines the presence of the consumer by: detecting a connection of one or more user devices to the network device; determining one or more presence devices of the one or more connected user devices; and determining that a presence device of the one or more presence devices is associated with the consumer.

The one or more user devices may each be associated with a respective user, each of which may be the consumer. A distinction is made between a user and a consumer, wherein a user may be a device user present within the network zone, whilst the consumer may be an actual consumer of the content item. Thus, in some embodiments wherein a single user device is connected to the network device, there may be single user present which may be the consumer. Alternatively, in some embodiments wherein a plurality of user devices are connected to the network device, there may be one or more users of the plurality of users that are the consumer.

The presence device may refer to a device associated with a user that indicates the presence of the user. For example, the presence device may be a smartphone or a smartwatch. Such a presence device may be distinct from a device that is associated with the user, but does not necessarily indicate the presence of the user, such as a wireless printer. The skilled person will appreciate that the presence device may be any device suitable for indicating the presence of the user.

In this way, the system may detect the presence of one or more users based on a connection of devices associated with the one or more users. The system may also determine which of the users the consumer is. Furthermore, the system may distinguish between the consumer of the content item, and users of presence devices that are within the network zone but are not a consumer of the content item. Advantageously, system may determine the presence of the consumer amongst one or more users without the use of personal data.

Preferably, the presence determination component determines that the presence device of the one or more presence devices is associated with the consumer based on a consumer probability associated with the presence device.

In particular, the presence determination component may determine that the user of the presence device having the highest consumer probability is the consumer. In this way, the system may identify the consumer from one or more potential users based on the likelihood that the user is the consumer. Advantageously, the system may identify the consumer without the use of personal data.

In some embodiments, the consumer probability is determined determining a consumer probability associated with the presence device based on: historic device data in the device database; and historic content metadata in the content database.

The current content metadata may be metadata indicative of the type of content currently being provided to the content device. For example, the current content metadata may be indicative of a genre of the current content. The historic device data may be representative of the one or more presence devices determined to be connected to the network device. The historic content metadata may be data representative of content items that have previously been consumed by the users of the respective presence devices. That is, each respective presence device may have an associated one or more historic content metadata indicative of content previously consumed by the user of the presence device.

The consumer probability may be determined following Bayes theorem:

$$p ( A \vert B ) = \frac{p ( A ) \times p ( B \vert A )}{p ( B )}$$

wherein:
A is a set of one or more users associated with the one or more presence devices;
B is the content item;
p(A|B) is the probability that the set of one or more users are consuming the content item;
p(A) is the probability that the set of one or more users are interacting with the content device;
p(B|A) is the probability that the content item is being consumed by the set of one or more users; and
p(B) is the probability that the content item is provided on the content device.

The skilled person will appreciate that p(B) is 1 because the content item is known.

The presence determination component may repeat the consumer probability determination for each combination of users such that a consumer probability may be associated with each combination. Thus, the consumer may be determined to be one or more users.

Preferably, the presence determination component determines that the device is a presence device by: determining a device identifier of the device; comparing the device identifier to a list of presence device identifiers stored on the device database and determining that the device identifier matches an identifier of a presence device.

The device identifier may be a unique identifier associated with the device. For example, the device identifier may be a media access control address (MAC address) associated with the device. Further device identifiers may be envisaged. In this way, the system may determine the presence of the user by identifying that the device identifier of a connected device matches the device identifier of a device that has been determined to indicate that a user is present within the network zone. Advantageously, the system may determine the presence of the user using minimal data.

In some embodiments, the one or more presence devices comprises one or more first presence devices.

A first presence device may refer to a device which is highly indicative of the presence of a user within the network zone. In other words, the first presence device may be a primary means for determining whether a user is present within the network zone. An example first presence device may be a smartphone or a smartwatch. A plurality of first presence devices may be associated with a single user. In this way, the system may determine the presence of a user within the network zone based on the connection of a device to the network device, the device having a strong indication of user presence. Advantageously, the system may determine the presence of a user within the network zone with an increased degree of certainty.

Preferably, the one or more first presence devices determined by: determining a connection independency score for each device associated with the list of device identifiers; and selecting a device having a connection independency score that meets an independency threshold.

A connection independency score may refer to a score representative of degree in which a device is connected to the network device independent of other devices. The connection independency score may be a percentage value. A higher connection independency score may be indicative of the device connecting to the network device independently of other devices being connected to the network device. For example, a smartphone may have a higher connection independency score than a wireless printer, because the smartphone may connect to the network device whilst no other devices are connected to the network device, whereas the wireless printer may mostly connect to the network device whilst another device is connected. A lower connection independency score may be indicative of a device connecting to the network device when one or more other devices are also connected to the network device. For example, a laptop may have a lower connection independency score because it connects to the network device whilst the user's smartphone is also connected to the network device.

The connection independency score may be dynamically updated by the presence determination component as devices connect and disconnect with the network device over time. In this way, the presence determination component may adapt the list of first presence devices over time. Advantageously, the system may determine a more reliable connection independency score as devices connect and disconnect with the network device over time.

Preferably, the one or more presence devices further comprises one or more second presence devices.

A second presence device may refer to a device which may be associated with at least one of the first presence device. The second presence device may be indicative of the presence of a user within the network zone than the first presence device. In other words, the second presence device may be the secondary means for determining whether a user is present within the network zone. An example second presence device may be a laptop. In this way, second user-devices may be grouped and associated with first user-devices. Advantageously, a set of devices may be grouped and associated with a user.

In some embodiments, the one or more second presence devices are determined based on a network event overlap between a device and the one or more first presence devices.

The network event overlap may refer to a fraction of network events that overlap with a period of time in which at least one first presence device is connected to the network. A network event may be, for example, a connection or a disconnection with the network device.

In some embodiments, generation of the personalised content item comprises: determining an interest of the consumer based on content metadata stored in the content database; and generating the personalised content item based on the interest of the consumer.

Content metadata may refer to data indicative of a content type of the one or more content items that have previously been presented to the consumer. For example, the content metadata may indicate a genre of the respective previously presented content item. It will be understood by the skilled person that different consumers having different associated presence devices may each have content metadata associated with them. In this way, the system may maintain a historic record of content items that have been consumed by each user.

In some embodiments, generating the personalised content item further comprises: determining an attribute of the consumer; and generating the personalised content item based on the interest of the consumer and the attribute of the consumer.

In accordance with a second aspect of the present disclosure, there is provided a content personalisation method, comprising the steps of: determining, by a presence determination component, the presence of a user based on data in a device database; determining, by a content generation component, a personalised content item based on data in the content database; and providing, by the content generation component, the personalised content item to the user.

Preferably, the presence of the consumer is determined by: detecting, by the presence determination component, a connection of one or more user devices to a network device; and determining, by the presence determination component, one or more presence devices of the one or more connected user devices; and determining, by the presence determination component, that a presence device of the one or more presence devices is associated with the consumer.

Preferably, the presence determination component determines that the presence device of the one or more presence devices is associated with the consumer based on a consumer probability associated with the presence device.

Preferably, the consumer probability is determined based on: current content metadata; historic device data in the device database; and historic content metadata in the content database.

Preferably, the presence determination component determines that the device is a presence device by: determining a device identifier of the device; comparing the device identifier to a list of presence device identifiers stored on the device database; and determining that the device identifier matches an identifier of a presence device.

Preferably, the one or more presence devices comprises one or more first presence devices.

Preferably, the one or more first presence devices are determined by: determining, by the presence determination component, a connection independency score for each device associated with the list of device identifiers; and selecting, by the presence determination component, a device having a connection independency score that meets an independency threshold.

Preferably, the one or more presence devices further comprises one or more second presence devices.

Preferably, the one or more second presence devices are determined based on a network event overlap between a device and the one or more first presence devices.

Preferably, generation of the personalised content item comprises: determining an interest of the consumer based on content metadata stored in the content database; and generating the personalised content item based on the interest of the consumer.

Preferably, generating the personalised content item further comprises: determining an attribute of the consumer; and generating the personalised content item based on the interest of the consumer and the attribute of the consumer.

It will be appreciated that any features described herein as being suitable for incorporation into one or more aspects or embodiments of the present disclosure are intended to be generalizable across any and all aspects and embodiments of the present disclosure. Other aspects of the present disclosure can be understood by those skilled in the art in light of the description, the claims, and the drawings of the present disclosure. The foregoing general description and the following detailed description are exemplary and explanatory only and are not restrictive of the claims

### BRIEF DESCRIPTION OF THE DRAWINGS

The invention will now be described by way of example only with reference to the following Figures in which:

FIG. 1 shows a systematic view of a content personalisation system according to a first aspect of the present disclosure; and

FIG. 2 shows a flow diagram of a content personalisation method according to a second aspect of the present disclosure;

FIG. 3 shows a consumer presence determination method; and

FIG. 4 shows a personalised content generation method.

### DETAILED DESCRIPTION

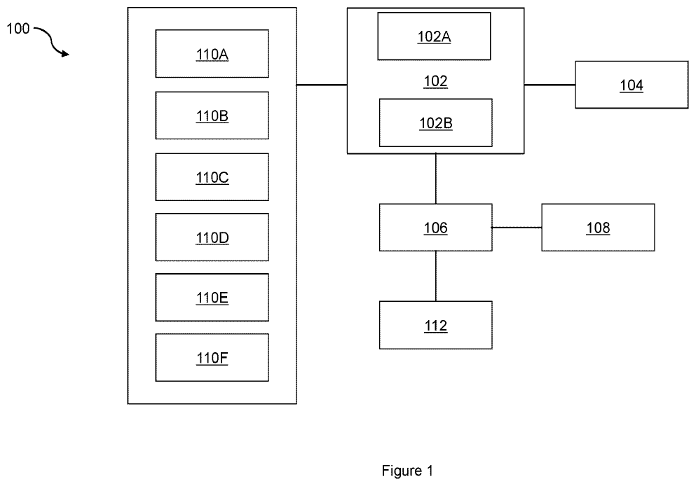

FIG. 1 shows a systematic view of a content personalisation system 100 according to a first aspect of the present disclosure.

The system 100 comprises a presence determination component 102, a device database 104, a content generation component 106, and a content database 108.

In the present example, the system 100 is in communication with a content device 112. The content device 112 is a display 112.

The system is also in communication with a server (not shown). The server comprises data indicative of locations associated with respective IP addresses.

The system 100 is also in communication with a first user device 110A, a second user device 110B, a third user device 110C, a fourth user device 110D, a fifth user device 110E, and a sixth user device 110E.

The presence determination component 102 comprises a network device 102A, such as a router 102A. The presence determination component 102 also comprises a processor 102B.

The router 102A is configured to receive and provide data to one or more user devices. The router 102A defines a network zone in which devices are able to connect to the router 102A.

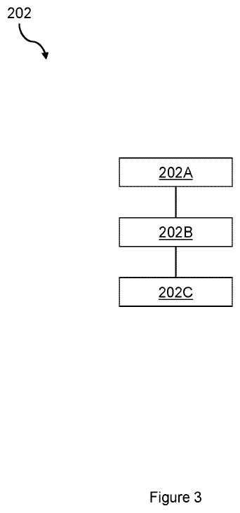

The processor 102B is configured to execute the steps of the consumer presence determination method 202 shown in FIG. 3. The processor 102B is also configured to store, on the device database 104, a device identifier associated with each of the one or more user devices connected to the router 102A.

The presence determination component 102 is configured to determine the presence of one or more consumers within the network zone according to the consumer presence determination method 202 shown in FIG. 3.

The device database 104 comprises a plurality of records, each recording corresponding to a user device that is connected, or has previously been connected, to the router 102A. That is, the device database 104 is a historic record of user devices that have connected to the router 102A. Each record of the device database 104 comprises a device identifier of the respective user device. In particular, each record comprises a media access control address (MAC address) of the respective device. Each record of the device database 104 also comprises temporal data corresponding to a period of time in which the respective device was connected to the router 102A.

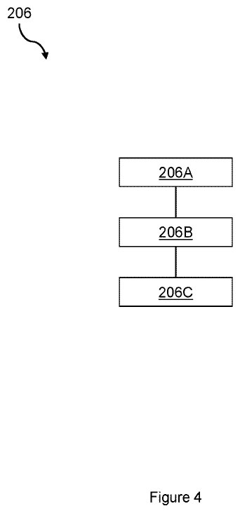

The content generation component 106 is configured to provide a current content item to the display 112. For example, the content generation component 106 may be configured to provide a video stream to the display 112. Additionally, the content generation component 106 is configured to generate a personalised content item according to the personalised content generation method 206 of FIG. 4, and provide the personalised content item to the display 112.

The content database 108 comprises a plurality of records. The plurality of records comprises records, each associated with a respective consumer of one or more previous content items. Each record comprises data representative of the one or more previous content items consumed by the respective consumer. For example, the data may be content metadata indicative of a genre of each content item. The plurality of records also comprises records, each associated with a respective combination of consumers.

It will be understood that, whilst the presence determination component 102 and the content generation component 106 have been described as comprising respective processors 102B, 104B, the system may comprise a central processor configured to operate in communication with the components of the system.

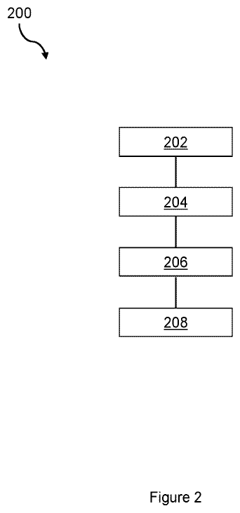

FIG. 2 shows a flow diagram of a content personalisation method 200 according to a second aspect of the present disclosure. The content personalisation method 200 is executed using the system 100.

The content personalisation method 200 is configured to provide a personalised content item to the display 112. In the present example, there is a first user, a second user, and a third user present in the network zone.

The first user device 110A is a first mobile phone 110A associated with the first user, the first mobile phone 110A being connected to the router 102A. The second user device 110B is a first smart-watch 110B associated with the first user, the smartwatch 110B being connected to the router 102A. The third user device 110C is a second mobile phone 110C associated with the second user, the second mobile phone 110C being connected to the router 102A. The fourth user device 110D is a laptop device 110D associated with the second user, the laptop device being connected to the router 102A. The fifth user device 110E is a mobile phone 110E associated with the third user, the mobile phone 110E being connected to the router 102A. The sixth user device 110F is a communal user device, such as a wireless printer 110F that is not associated with a particular user, the wireless printer 110F being connected to the router 102A.

In a first step 202 of the method 200, the presence determination component 102 determines the presence of the ones or more consumers within the network zone of the router 102A. The presence determination component 102 determines the presence of the one or more consumers based on data stored in the device database 104.

A distinction is made between a user and a consumer. A user is the user of a user-device within the network zone, whilst a consumer is a user of a user-device within the network zone that is also consuming content on the display 112.

More detail regarding step 202 is described in relation to the presence determination method 202 shown in FIG. 3.

In a second step 204, the content generation component 106 provides a current content item to the content device 112 associated with the one or more consumers. As discussed above, the content generation component 106 provides, for display on the display 112, a video stream.

In a third step 206, the content generation component 106 generates a personalised content item based on data stored in the content database 108.

More detail regarding step 206 is described in relation to the personalised content generation method 206 of FIG. 4.

In a final step 208, the content generation component 106 provides the personalised content item to the content device. In particular, the content generation component 106 causes, for display on the display 112, the personalised content item.

Therefore, the one or more consumers are provided a personalised content item based on their unique attributes and historically consumed content.

Turning now to FIG. 3, there is shown a consumer presence determination method 202 using the presence determination component 102 of the system 100.

In a first step 202A of the presence determination method 202, the presence determination component 102 detects a connection of one or more user devices to the router 102A. In particular, the processor 102B of the presence determination component 102 determines that the router 102A is receiving and providing data to the one or more user devices.

In the present example, the presence determination component 102 detects the connection of the first user device 110A, the second user device 110B, the third user device 110C, the fourth user device 110D, the fifth user device 110E, and the sixth user device 110F.

In step 202B, the presence determination component 102 determines one or more presence devices of the one or more connected user devices detected in step 202A.

In particular, the presence determination component 102 determines a device identifier associated with each of the user devices 110A-110F. The device identifiers are received by the router 102A and as such, the processor 102B is able to read the device identifiers from the router 102A. The presence determination component 102 compares the device identifier of each of the user devices 110A-110F to presence device identifiers in the device database 104. If the device identifier of the user device matches the presence device identifier, it is determined to be a presence device.

The presence devices comprise first presence devices and second presence devices which are determined by the processor 102B. The first presence devices refer to devices that are highly indicative of the presence of a user. The second presence devices refer to devices that are associated with the first presence devices that may also be used to determine whether a user is present.

The first presence devices are determined by determining a connection independency score for each device associated with the records of the content database. The connection independency score refers to a score representative of degree in which a device is connected to the router 102A independent of whether other devices are connected to the router 110A or not.

The connection independency score is determined for each device by determining a set of devices that were connected to the router 102A over a particular time period. These devices are determined by the processor 102B by selecting the time period and determining, from the associated records of the content database, network events that occurred during that time period.

Devices that were connected to the router 102A for a period that meets a presence device threshold of, for example, 90% are removed from eligibility as presence devices. That is, devices that are connected to the router 102A for 90% of the time period are removed. These devices are devices that are “always on” and do not represent the presence of a user. Network events wherein devices that had disconnected from the router and reconnected within a threshold time period are removed as network events.

The processor 110B iteratively compares, for each device of the set of devices, times in which each other device is connected to the router 110A. Independent devices are devices in which a small fraction of network events associated with the device occurs when any other device is connected to the router 110A. Dependent devices are devices in which a larger fraction of network events associated with the device occurs when at least one other device of the set of devices is connected to the router 110A. The processor 110B normalises the fractions for each device to the time that each other device is connected to the router 110A so that the fractions can be compared. Devices of the set of devices which are determined to meet a threshold independence score are tagged as first presence devices, wherein the independence score is 1 divided by the fraction. The first presence devices are used to determine the second presence devices.

In the present example, the first mobile phone 110A is a first presence device because it connects to the router 102A independently of any other device. The second mobile phone 110C is also a first presence device because it connects to the router 102A independently of any other device. The third mobile phone 110E is also a first presence device because it connects to the router 102A independently of any other device.

The second presence devices are determined by determining a portion of network events, such as network connections to the router 102A, that overlap with times that the first presence devices are connected to the router 102A. For example, when a first presence device such as the first mobile phone 110A is connected to the router 102A, a second presence device such as the laptop device 110D is observed as connected and disconnecting with the router 102A before the first mobile phone 110A disconnects from the router 102A due to leaving the network zone. Therefore, the laptop device 110D is interacted with (i.e. connects and/or disconnects to the router 102A) when the first mobile phone 110A is connected to the router 110A.

A second presence device is determined by iterating over each first presence device and determining a number of network events that occurred whilst each first presence device was connected as a fraction of the total number of network events for each secondary device. Each second presence device is matched to a first presence device based on the highest fraction of network events. In particular, if the laptop device 110D connects and/or disconnects with the router 102A 92% of the time whilst the first mobile phone 110A is connected, and connects and/or disconnects with the router 56% of the time whilst the second mobile phone 110C is connected, the laptop device 110D will be matched with the first mobile device 110A.

This fraction is used as a likelihood of the respective associated user being present in the event that the matched first presence device is not connected.

In the present example, the first smartwatch 110B is a second presence device associated with the first mobile phone 110A because it historically most often connects and/or disconnects to the router 102A whilst the first mobile phone 110A is connected to the router 102A. The laptop device 110D is a second presence device associated with the second mobile phone 110C because it historically most often connects and/or disconnects to the router 102A whilst the second mobile phone 110C is connected to the router 102A.

The wireless printer 110F is neither a first presence device, nor a second presence device because it has a low fraction of network events which overlap with the connection of and of the individual first presence devices with the router 102A.

In step 202C, the presence determination component 102 determines that one or more presence devices of the one or more connected user devices is associated with the one or more consumers. That is, the presence determination component 102 determines that one or more of the presence devices are associated with a user that is currently consuming the content item (i.e. a consumer).

In particular, the presence determination component 102 determines that the presence device of the one or more presence devices is associated with the one or more consumers based on a consumer probability associated with the presence device.

The consumer probability is determined according to Bayes theorem:

$$p ( A \vert B ) = \frac{p ( A ) \times p ( B \vert A )}{p ( B )}$$

wherein:
A is a set of one or more users associated with the one or more presence devices; B is the content item;
p(A|B) is the probability that the set of one or more users are consuming the content item;
p(A) is the probability that the set of one or more users are interacting with the content device;
p(B|A) is the probability that the content item is being consumed by the set of one or more users; and
p(B) is the probability that the content item is provided on the content device.

The consumer probability is determined for each combination of users. Accordingly, the consumer probability is determined for one or more values of A. In the present example, the consumer probability is determined for: the first user; the first user and the second user; the first user and the third user; the second user; the second user and the third user; and the third user.

The skilled person will appreciate that p(B) is 1 for each consumer probability determination because the content item is known.

In the present example, the highest consumer probability is determined to be the first user and the third user.

Thus, the one or more consumers is determined to be the first user and the third user.

FIG. 4 shows a personalised content generation method 206 executed by the content generation component 106.

In a first step 206A, the content generation component 106 determines an interest of the one or more consumers. That is, the content generation component 106 determines a shared interest of the first user and the third user. The interest determination is based on the content metadata of the content database 108 stored on the record associated with the first and third user. In particular, the content generation component 106 determines the interest based on content previously consumed by the first and third consumers at the same time.

In a second step 206B, the content generation component 106 determines an attribute of the one or more consumers. That is, the content generation component 106 determines an attribute of the first user and an attribute of the third user. The attribute comprises an age, a gender, and a socio-economic (SEC) code.

The socio-economic code is determined by identifying a location of the content generation component 106. In particular, the content generation component 106 submits a location request to the server, the request comprising an IP address of the router 110A. The location request is encrypted using a secure HTTPS. A processor of the server then determines a location associated with the IP address stored on the server. The server subsequently sends the location to the content generation component 106. In this way, the privacy of the consumer is protected.

The age of each consumer is extracted from the SEC code of the location.

The gender of each consumer is determined by comparing the interests of each consumer to survey data that relates interests to gender. This comparison method is a maximum likelihood estimation algorithm which compares the interests of each consumer to the interests for each gender in the dataset; this method chooses the gender which has the ‘closest’ set of interests to the respective consumer.

In a third step 206C, the content generation component 106 generates the personalised content item based on the interests, SEC code, age, and gender of the first consumer and the third consumer.

In this way, the personalised content item is generated without the processing of personal data, whilst collecting a minimum amount of data. Furthermore, no personal data is shared with third parties.

The description provided herein may be directed to specific implementations. It should be understood that the discussion provided herein is provided for the purpose of enabling a person with ordinary skill in the art to make and use any subject matter defined herein by the subject matter of the claims.

It should be intended that the subject matter of the claims not be limited to the implementations and illustrations provided herein, but include modified forms of those implementations including portions of implementations and combinations of elements of different implementations in accordance with the claims. It should be appreciated that in the development of any such implementation, as in any engineering or design project, numerous implementation-specific decisions should be made to achieve a developers' specific goals, such as compliance with system-related and business related constraints, which may vary from one implementation to another. Moreover, it should be appreciated that such a development effort may be complex and time consuming, but would nevertheless be a routine undertaking of design, fabrication, and manufacture for those of ordinary skill having benefit of this invention.

Reference has been made in detail to various implementations, examples of which are illustrated in the accompanying drawings and figures. In the detailed description, numerous specific details are set forth to provide a thorough understanding of the invention provided herein. However, the invention provided herein may be practiced without these specific details. In some other instances, well-known methods, procedures, components, circuits, and networks have not been described in detail so as not to unnecessarily obscure details of the embodiments.

It should also be understood that, although the terms first, second, etc. may be used herein to describe various elements, these elements should not be limited by these terms. These terms are only used to distinguish one element from another. For example, a first element could be termed a second element, and, similarly, a second element could be termed a first element. The first element and the second element are both elements, respectively, but they are not to be considered the same element.

The terminology used in the description of the invention provided herein is for the purpose of describing particular implementations and is not intended to limit the invention provided herein.

As used in the description of the invention provided herein and appended claims, the singular forms “a,” “an,” and “the” are intended to include the plural forms as well, unless the context clearly indicates otherwise. The term “and/or” as used herein refers to and encompasses any and all possible combinations of one or more of the associated listed items. The terms “includes,” “including,” “comprises,” and/or “comprising,” when used in this specification, specify a presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

While the foregoing is directed to implementations of various techniques described herein, other and further implementations may be devised in accordance with the invention herein, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The invention claimed is:

1. A content personalisation system comprising:
a presence determination component in communication with a device database, the presence determination component comprising a network device defining a network zone;
wherein the presence determination component is configured to:
determine the presence of a consumer within the network zone based on data in the device database;
a device database in communication with the presence determination component;
a content generation component in communication with the presence determination component, a content database, and a content device;
wherein the content generation component is configured to:
provide a current content item to the content device associated with the consumer;
generate a personalised content item based on data in the content database associated with the consumer; and
provide the personalised content to the content device; and wherein:
the device database comprises data indicative of one or more devices that have previously connected to the network device; and
the content database comprises data indicative of one or more content items that have been previously presented.

2. The system of claim 1, wherein the presence determination component determines the presence of the consumer by:
detecting a connection of one or more user devices to the network device;
determining one or more presence devices of the one or more connected user devices; and
determining that a presence device of the one or more presence devices is associated with the consumer.

3. The system of claim 2, wherein the presence determination component determines that the presence device of the one or more presence devices is associated with the consumer based on a consumer probability associated with the presence device.

4. The system of claim 3, wherein the consumer probability is based on:
current content metadata;
historic device data in the device database; and
historic content metadata in the content database.

5. The system of claim 2, wherein the presence determination component determines that the device is a presence device by:
determining a device identifier of the device;
comparing the device identifier to a list of presence device identifiers stored on the device database; and
determining that the device identifier matches an identifier of a presence device.

6. The system of claim 2, wherein the one or more presence devices comprises one or more first presence devices.

7. The system of claim 6, wherein the one or more first presence devices are determined by:
determining a connection independency score for each device associated with the list of device identifiers; and
selecting a device having a connection independency score that meets an independency threshold.

8. The system of claim 6, wherein the one or more presence devices further comprises one or more second presence devices.

9. The system of claim 8, wherein the one or more second presence devices are determined based on a network event overlap between a device and the one or more first presence devices.

10. The system of claim 1, wherein generation of the personalised content item comprises:
determining an interest of the consumer based on content metadata stored in the content database; and
generating the personalised content item based on the interest of the consumer.

11. The system of claim 10, wherein generating the personalised content item further comprises:
determining an attribute of the consumer; and
generating the personalised content item based on the interest of the consumer and the attribute of the consumer.

12. A content personalisation method, comprising the steps of:
determining, by a presence determination component, the presence of a consumer within a network zone based on data in a device database;
providing, by a content generation component, a current content item to a content device associated with the consumer;
generating, by the content generation component, a personalised content item based on data in a content database associated with the consumer; and
providing, by the content generation component, the personalised content item to content device.

13. The method of claim 12, wherein the presence of the consumer is determined by:
detecting, by the presence determination component, a connection of one or more user devices to a network device; and
determining, by the presence determination component, one or more presence devices of the one or more connected user devices; and
determining, by the presence determination component, that a presence device of the one or more presence devices is associated with the consumer.

14. The method of claim 13, wherein the presence determination component determines that the presence device of the one or more presence devices is associated with the consumer based on a consumer probability associated with the presence device.

15. The method of claim 14, wherein the consumer probability is determined based on:
current content metadata;
historic device data in the device database; and
historic content metadata in the content database.

16. The method of claim 12, wherein the presence determination component determines that the device is a presence device by:
determining a device identifier of the device;
comparing the device identifier to a list of presence device identifiers stored on the device database; and
determining that the device identifier matches an identifier of a presence device.

17. The method of claim 12, wherein the one or more presence devices comprises one or more first presence devices.

18. The method of claim 17, wherein the one or more first presence devices are determined by:
determining, by the presence determination component, a connection independency score for each device associated with the list of device identifiers; and
selecting, by the presence determination component, a device having a connection independency score that meets an independency threshold.

19. The method of claim 17, wherein the one or more presence devices further comprises one or more second presence devices.

20. The method of claim 19, wherein the one or more second presence devices are determined based on a network event overlap between a device and the one or more first presence devices.

21. The method of claim 12, wherein generation of the personalised content item comprises:
determining an interest of the consumer based on content metadata stored in the content database; and
generating the personalised content item based on the interest of the consumer.

22. The method of claim 21, wherein generating the personalised content item further comprises:
determining an attribute of the consumer; and
generating the personalised content item based on the interest of the consumer and the attribute of the consumer.
